(19) United States
(12) Patent Application Publication
(10) Pub. No.: US 2007/0269264 A1
(43) Pub. Date: Nov. 22, 2007

(54) SAFETY TILE FOR PEDESTRIAN TACTILE DETECTION

(76) Inventor: Hratch Paul Boghossian, Glendale, CA (US)

Correspondence Address: QUICKPATENTS, INC., 32861 CALLE PERFECTO, SUITE A, SAN JUAN CAPISTRANO, CA, 92675, US

(21) Appl. No.: 11/306,556

(22) Filed: Jan. 2, 2006

(51) Int. Cl. E01C 5/00; A61H 3/06; E01C 11/24

(52) U.S. Cl. 404/19; 116/205; 404/34; 404/73

(57) ABSTRACT

A safety tile for embedding into a pedestrian-accessible surface, and a method of its use, are disclosed. The safety tile comprises a substantially planar tile member that includes an upper surface, a lower surface, and at least one side surface. The upper surface includes a plurality of projections extending upwardly therefrom, and the lower surface includes a plurality of downwardly projecting ribs. A plurality of anchor bolts are included that traverse the tile member from the upper surface to the lower surface through an aperture therein. Preferably the projections are shaped and pattered so as to be compliant with the Americans with Disabilities Act Accessibility Guidelines. The rounded head of each anchor bolt is preferably shaped and patterned similarly to each of the plurality of projections and positioned on the upper surface so that the rounded head of each anchor bolt takes the place of one projection in the pattern. In use, after the tile is set into an uncured surface material, each anchor bolt is tapped down into the uncured material to be captured thereby.

### CROSS-REFERENCE TO RELATED APPLICATIONS

Not applicable.

### STATEMENT REGARDING FEDERALLY SPONSORED RESEARCH AND DEVELOPMENT

Not Applicable.

### FIELD OF THE INVENTION

This invention relates to embedded sidewalk tiles, and more particularly to an embedded sidewalk tile for detection by visually impaired pedestrians.

### DISCUSSION OF RELATED ART

The Americans with Disabilities Act requires that certain walkway surfaces accessible by the public to be detected tactilely by visually impaired persons. Such tactilely detectable surfaces serve as warnings concerning hazards such as traffic crossings, stairways, curb ramps, loading docks, stages and other elevated platforms, and the like. As such, several prior art devices have been devised for adding a tactilely detectable pattern in existing pedestrian-accessible surfaces adjacent to potential hazards.

For example, U.S. Pat. No. 5,775,835 on Jul. 7, 1998 to Szekely, teaches an embedment tile for pedestrian platforms and walkways.

Such a device has the drawback, however, of air becoming trapped under the tile during installation. Over time air under such a tile causes a bottom surface of the tile to lift off of the cement embedment material and bow undesirably.

U.S. Pat. No. 5,303,669 on Apr. 19, 1994, also to Szekely, teaches a similar tile with, in one embodiment shown in FIG. 10, a concrete nail used to secure the tile to the surface. Such a tile is designed for installation over an existing hardened surface. A cap is fitted over the concrete nail, and is secured there by adhesive. However, over extended use in the elements these caps frequently become removed, exposing the nail head to pedestrians. Further, over time such mechanical concrete nail can become loose, particularly near transit thoroughfares where structural vibration is common.

Another prior art device, taught in US Patent Application 2005/0066623 to Sippola and published on Mar. 31, 2005, includes a plurality of V-shaped channels on a bottom surface thereof. Such channels include through-holes that allow curing cement, or the like, to flow therethrough and capture the tile upon curing. Nevertheless, such a device still does not fully expel trapped air from under the tile during installation, and such trapped pockets of air, over time, cause the tile to buckle and bow undesirably. Further, the V-shaped channels of such a device are optimally made of stainless steel, which increases the cost of manufacturing such a device.

Therefore, there is a need for an inexpensive safety tile that eliminates trapped air from underneath the tile during installation. Such a needed device would be relatively inexpensive to manufacture, easy to install, and would remain firmly in place with no buckling or bowing of the top surface even after an extended duration of exposure to weather elements. Such a needed device could be fashioned in a variety of different shapes and colors as needed, and would provide for protection against damage during installation. The present invention accomplishes these objectives.

### SUMMARY OF THE INVENTION

The present device is a safety tile for embedding into a pedestrian-accessible surface, such as a sidewalk or a train platform. The safety tile comprises a substantially planar tile member that includes an upper surface, a lower surface, and at least one side surface. The upper surface includes a plurality of projections extending upwardly therefrom, while the lower surface includes a plurality of downwardly projecting ribs. The downwardly projecting ribs together form a plurality of generally rectangular compartments on the lower surface.

A plurality of anchor bolts are included, each of which comprises a threaded bolt member and an anchor nut. Each threaded bolt member includes a generally rounded head and a threaded shaft. Each anchor bolt traverses the tile member from the upper surface to the lower surface through an aperture therein.

Preferably the projections are shaped and pattered so as to be compliant with the Americans with Disabilities Act Accessibility Guidelines for pedestrian crossings into dangerous areas, such as at roadway intersections, train platforms, and the like. Further, the rounded head of each anchor bolt is preferably shaped and patterned similarly to each of the plurality of projections. Moreover, each anchor bolt is positioned on the upper surface so that the rounded head of each anchor bolt takes the place of one projection in the pattern.

In use, the surface is prepared with an unhardened concrete, cement, asphalt, or other curable surface material. The safety tile is positioned above the surface at a desired location, and downward force is applied to the top surface of the safety tile. As the safety tile becomes embedded in the surface material, air trapped under the safety tile is expelled through the apertures such that the surface material may fully expel the air and make firm contact with the lower surface of the safety tile. Once the upper surface is substantially flush with the surrounding surface, with the projections exposed and raised above a plane of the surrounding surface, each anchor bolt may be tapped or pounded down into the uncured surface material. Each anchor bolt is forced down until the rounded head makes contact with the upper surface of the safety tile, such that the uncured surface material flows around the anchor bolt and the threaded shaft to fully capture same. Upon curing, the surface material firmly grips each anchor bolt, thereby firmly holding the safety tile to the surface.

The present invention is an inexpensive safety tile that fully expels trapped air from underneath the tile during installation. The present invention is relatively inexpensive to manufacture, easy to install, and remains firmly in place with no buckling or bowing of the top surface even after an extended duration of exposure to weather elements. The present device may be easily fashioned in a variety of different shapes and colors as needed, and provides for protection against damage during installation. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective illustration of a safety tile of the invention;

FIG. 2 is a top plan view of the invention;

FIG. 3 is an enlarged, partial top-plan view of the invention, taken generally along lines 3-3 of FIG. 2;

FIG. 4 is a cross-sectional view of the invention, taken generally along lines 4-4 of FIG. 2;

FIG. 5A is a partial cross-sectional view of the invention, taken generally along lines 5-5 of FIG. 4;

FIG. 5B is a partial cross-sectional view of the invention, taken generally along lines 5-5 of FIG. 4, illustrating the safety tile as embedded into a pedestrian-accessible surface;

FIG. 6A is a partial cross-sectional view of the invention, taken generally along lines 6-6 of FIG. 4, further illustrating an anchor bolt of the invention in a raised position;

FIG. 6B is a partial cross-sectional view of the invention, taken generally along lines 6-6 of FIG. 4, illustrating the anchor bolt of the invention in a lowered position;

FIG. 7A is a partial cross-sectional view of the invention, taken generally along lines 6-6 of FIG. 4, illustrating the anchor bolt of the invention in a raised position as the safety tile is pressed down into an uncured concrete, cement, or asphalt material;

FIG. 7B is a partial cross-sectional view of the invention, taken generally along lines 6-6 of FIG. 4, illustrating the anchor bolt of the invention having been pounded into the uncured concrete, cement, or asphalt material; and

FIG. 8 is a bottom plan view of the invention.

### DETAILED DESCRIPTION OF THE PREFERRED EMBODIMENT

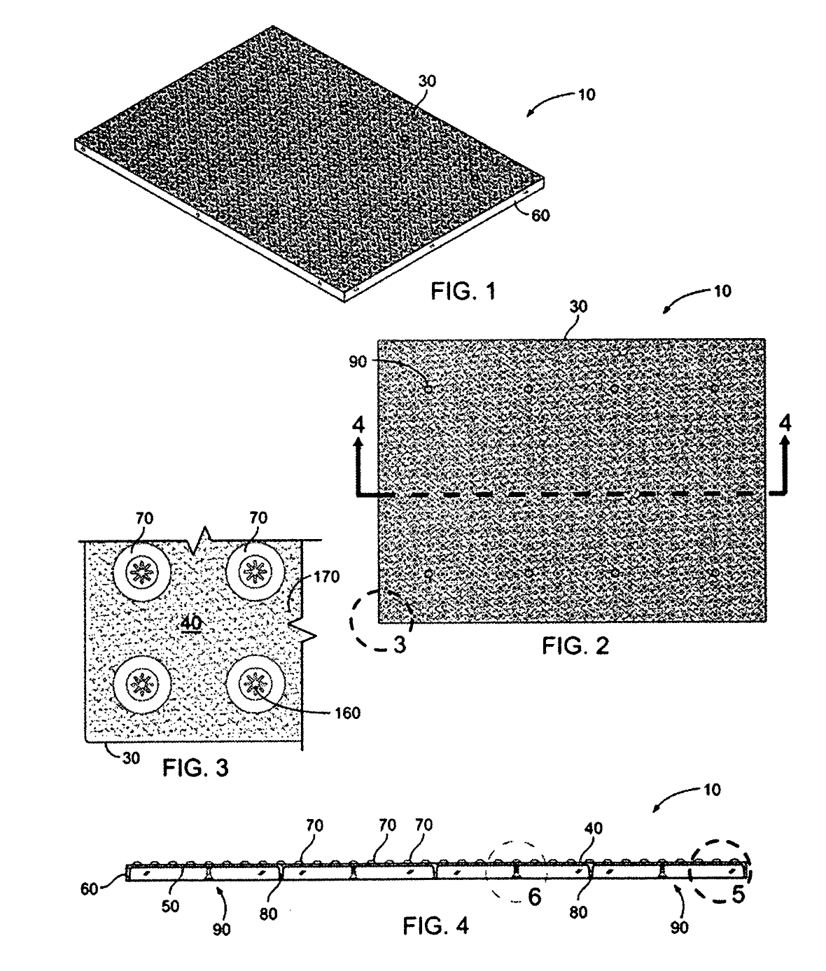

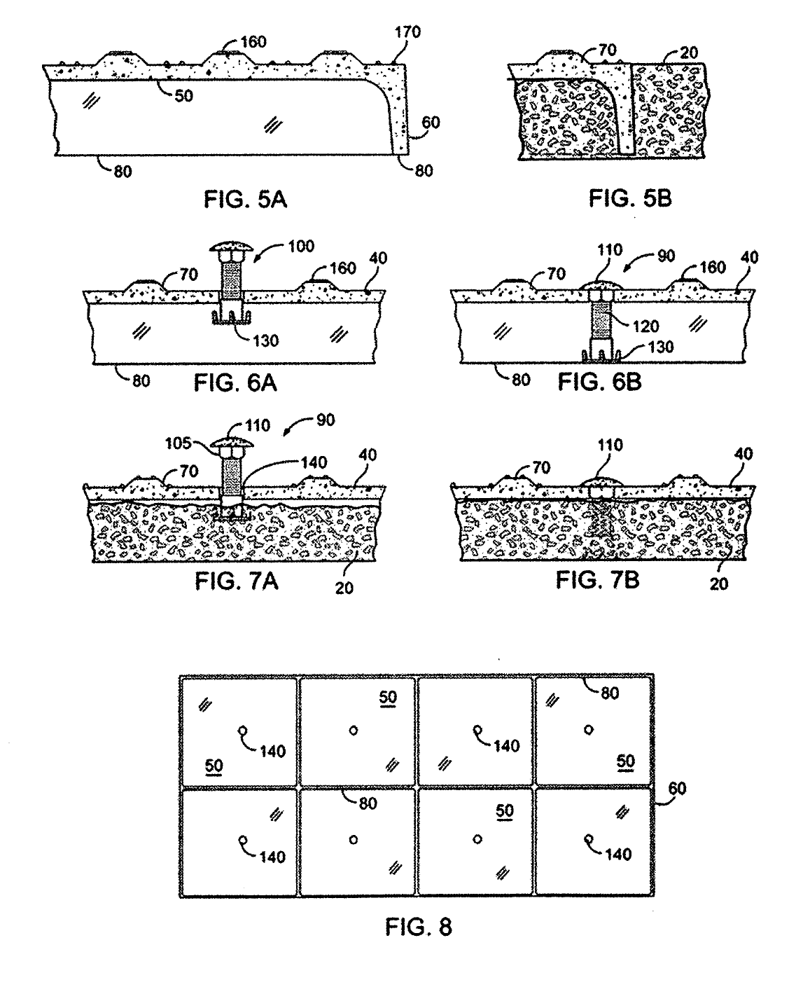

FIG. 1 illustrates a safety tile 10 for embedding into a pedestrian-accessible surface 20 (FIG. 5B), such as a sidewalk or a train platform. The safety tile 10 comprises a substantially planar tile member 30 that includes an upper surface 40, a lower surface 50, and at least one side surface 60. The upper surface 40 includes a plurality of projections 70 extending upwardly therefrom, while the lower surface 50 includes a plurality of downwardly projecting ribs 80 (FIGS. 4, 5, and 8). The downwardly projecting ribs 80 together form a plurality of generally rectangular compartments 105 on the lower surface 50 (FIG. 8).

The tile 10 is preferably formed with a strong, rigid, and durable material such as polymer concrete. Further, the tile 10 may be dyed a bright color to contrast with dark surface materials such as asphalt, or a dark color to contrast with light surface materials such as concrete. As such, visually impaired persons may more easily detect the presence of the tile 10. Further, the upper surface 50 may include a non-slip abrasive coating 170 (FIGS. 5 and 6B).

A plurality of anchor bolts 90 are included, each of which comprises a threaded bolt member 100 and an anchor nut 130. Each threaded bolt member 100 includes a generally rounded head 110 and a threaded shaft 120. Each anchor bolt 90 traverses the tile member 30 from the upper surface 40 to the lower surface 50 through an aperture 140 therein (FIGS. 6A, 7A, and 8). Each anchor bolt 90 further includes a neck 105 that, when forced into one of the apertures 140 of the safety tile 10 forms a substantially water tight seal therein. In the case where the neck 105 is hexagonal, each aperture 140 is correspondingly hexagonal and sized so as to create a snug fit with the neck 105. Alternately, the neck 105 may be circular in cross-section, whereby the apertures 140 are each similarly circular in shape.

The anchor nut 130 has a mating thread (not shown) for threaded engagement with the threaded shaft 120. However, preferably the anchor nut 130 may only be rotationally threaded to the lower-most portion of the threaded shaft 120 and frictionally locked thereto, so as to become rotationally fixed. Such a rotationally fixed threaded bolt member 100 cannot easily become disengaged from the anchor nut 130 over time and become loose.

Preferably the projections are shaped and pattered so as to be compliant with the Americans with Disabilities Act Accessibility Guidelines for pedestrian crossings into dangerous areas, such as at roadway intersections, train platforms, and the like. Further, the rounded head 110 of each anchor bolt 90 is preferably shaped and patterned similarly to each of the plurality of projections 70. Moreover, each anchor bolt 90 is positioned on the upper surface 40 so that the rounded head 110 of each anchor bolt 90 takes the place of one projection 70 in the pattern. One anchor bolt 90 is preferably included in an approximate center position of each rectangular compartment 150 of the lower side 50 of the safety tile 10 (FIG. 8).

Each projection 70 preferably includes a non-slip surface detail 160 protruding upwardly therefrom, such as shown in FIGS. 3 and 5.

Further, a protective vinyl coating 180 or other suitable coating is applied to the safety tile 10 to protect the surface 50 and projections 70 from damage during installation (FIG. 6A). Once installed, the protective coating 180 is removed from the tile 10.

In use, the surface 20 is prepared with an unhardened concrete, cement, asphalt, or other curable surface material. The safety tile 10 is positioned above the surface 20 at a desired location, and downward force is applied to the top surface 40 of the safety tile 10. As the safety tile 10 becomes embedded in the surface material, air trapped under the safety tile is expelled through the apertures 140 such that the surface material may fully expel the air and make firm contact with the lower surface 50 of the safety tile 10. Once the upper surface 40 is substantially flush with the surrounding surface 20, with the projections 70 exposed and raised above a plane of the surrounding surface 20, each anchor bolt 90 may be tapped or pounded down into the uncured surface material. Each anchor bolt is forced down until the rounded head 1 10 makes contact with the upper surface 40 of the safety tile 10, such that the uncured surface material flows around the anchor bolt 130 and the threaded shaft 120 to fully capture same. Upon curing, the surface material firmly grips each anchor bolt 90, thereby firmly holding the safety tile 10 to the surface 20.

While a particular form of the invention has been illustrated and described, it will be apparent that various modifications can be made without departing from the spirit and scope of the invention. For example, the safety tile 10 as shown in the drawings is generally rectangular. However, a safety tile 10 with a generally triangular, circular, or pie-shaped top-plan shape could also be made without departing from the scope of the invention. Further, a safety tile 10 with several straight sides 60 and one curved side (not shown) could also be made, such a tile 10 for placement near a rounded sidewalk curb, for example. Still further, the exact pattern of projections 70 may be altered as necessary, as may the exact positioning of the anchor bolts 90 on the safety tile 10. Accordingly, it is not intended that the invention be limited, except as by the appended claims.

What is claimed is:

1. An safety tile for embedding in a pedestrian-accessible surface, the safety tile comprising:
a substantially planar tile member comprising an upper surface, a lower surface, and at least one side surface, the upper surface including a plurality of projections extending upward therefrom, the lower surface including a plurality of downwardly projecting ribs, a plurality of anchor bolts each comprising a threaded bolt member having a generally rounded head and a threaded shaft, and an anchor nut, each anchor bolt traversing the tile member from the upper surface to the lower surface through an aperture therein;
whereby as the safety tile is embedded into the surface, air trapped below the tile is expelled through each of the apertures of the safety tile such that the upper surface of the safety tile is exposed and generally flush with the surrounding pedestrian-accessible surface.

2. The safety tile of claim 1 wherein the plurality of projections are shaped and patterned so as to be compliant with the Americans with Disabilities Act Accessibility Guidelines.

3. The safety tile of claim 2 wherein the rounded head is shaped and patterned similarly to each of the plurality of projections, and wherein each anchor bolt is positioned on the upper surface so that the rounded head of each anchor bolt takes the place of one projection in the pattern.

4. The safety tile of claim 1 wherein each anchor bolt further includes a neck that, when forced into one of the apertures of the safety tile, forms a substantially water tight seal therein.

5. The safety tile of claim 1 wherein the ribs form a plurality of generally rectangular compartments on the lower surface.

6. The safety tile of claim 5 wherein one of the plurality of anchor bolts is positioned at an approximately center location within the each rectangular compartment.

7. The safety tile of claim 1 wherein each of the plurality of projections includes a non-slip surface detail protruding upwardly therefrom.

8. The safety tile of claim 1 wherein the upper surface further includes a non-slip abrasive coating.

9. The safety tile of claim 1 further including a protective layer temporarily attached to the top surface thereof, whereby the protective layer may be readily removed after the safety tile is installed in the pedestrian-accessible surface.

10. A method of embedding a safety tile in a surface, the surface being formed of setting cement, concrete, or asphalt, comprising the steps of:
a.) providing a safety tile as recited in claim 1;
b.) positioning the safety tile above the surface in a desired location;
c.) applying a downward force to the tile so that the tile becomes embedded into the surface, air trapped under the safety tile being expelled through the apertures of the safety tile, until the upper surface is substantially flush with the surrounding surface and the projections are exposed and raised above a plane of the surrounding surface; and
d.) tapping each anchor bolt down into the setting cement, concrete, or asphalt until the rounded head contacts the upper surface, whereby setting cement, concrete or asphalt under the tile will surround and capture the anchor nut and anchor bolt as the cement, concrete or asphalt hardens.

11. A method of embedding a safety tile in a surface, the surface being formed of setting cement, concrete, or asphalt, comprising the steps of:
a.) providing a safety tile as recited in claim 9;
b.) positioning the safety tile above the surface in a desired location;
c.) applying a downward force to the tile so that the tile becomes embedded into the surface, air trapped under the safety tile being expelled through the apertures of the safety tile, until the upper surface is substantially flush with the surrounding surface and the projections are exposed and raised above a plane of the surrounding surface;
d.) tapping each anchor bolt down into the setting cement, concrete, or asphalt until the rounded head contacts the upper surface, whereby setting cement, concrete or asphalt under the tile will surround and capture the anchor nut and anchor bolt as the cement, concrete or asphalt hardens; and
e.) removing the protective coating from the top surface of the safety tile.
